(19) United States
(12) Patent Application Publication
(10) Pub. No.: US 2007/0055984 A1
(43) Pub. Date: Mar. 8, 2007

(54) Multi-tiered architecture for targeted ad insertion

(75) Inventors: Jay B. Schiller, Denver, CO (US); Joseph R. Matarese, Portland, OR (US)

Correspondence Address: OBLON, SPIVAK, MCCLELLAND, MAIER & NEUSTADT, P.C., 1940 DUKE STREET, ALEXANDRIA, VA, 22314, US

(73) Assignee: C-COR INCORPORATED, State College, PA (US)

(21) Appl. No.: 11/209,757

(22) Filed: Aug. 24, 2005

(51) Int. Cl. H04N 7/10; H04N 7/025

(52) U.S. Cl. 725/32; 725/34; 725/36

(57) ABSTRACT

A technique for multi-level ad insertion may include and/or involve identifying a device that provided an indication of an ad break in a program stream, attempting to select one or more ads particular to a region or regions served by the device, and if an ad or ads particular to a region or regions served by the device is selected, causing the ad or ads to stream to the device; otherwise, providing an indication to the device that the ad break should be retained in the program stream.

### TECHNICAL FIELD

The present disclosure relates to advertising insertion in program streams.

### BACKGROUND

Television signals delivered to viewers generally include the television programs themselves and commercial advertisements, which are typically inserted into breaks that occur regularly during broadcasts of the television programs. The commercial advertisements are typically created and stored separately from the programs. Then, at appropriate times during a broadcast, the commercial advertisements are spliced into the video feed so as to deliver the advertisements to viewers during program breaks. This provides flexibility for changing the commercial advertisements to be played during a program. For example, various different advertisements directed to local audiences may be inserted into a program that is broadcast over a much wider geographical area. As another example, different advertisements may be used during a rebroadcast of a program than when the program was originally broadcast. Thus, an important aspect of television delivery is program splicing and, more particularly, ad insertion.

Existing solutions have tended to involve distinct ad storage, streaming, and insertion systems for each region that will receive distinct advertising. This adds operational expense by causing duplication of the storage, streaming, and insertion of ads in multiple regions.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A technique for multi-level ad insertion may include and/or involve identifying a device that provided an indication of an ad break in a program stream, attempting to select one or more ads particular to a region or regions served by the device, and if an ad or ads particular to a region or regions served by the device is selected, causing the ad or ads to stream to the device; otherwise, providing an indication to the device that the ad break should be retained in the program stream.

An ad splicer that provides an indication of an ad break in a program stream may include and/or involve a device functioning as at least one of a stream splicer, stream multiplexer, or stream modulator.

The technique may include and/or involve identifying an ad break indication in a program stream, and signaling an ad selector with an indication that ad content should be provided for the ad break and with device identification information. When ad content is provided in response, the ad content may be inserted into the program stream at an ad break location, and the ad break indication removed from the program stream. Otherwise, the ad break indication may be retained in the program stream. Retaining the ad break indication in the program stream may result in detection of the ad break indication by a downstream device, the downstream device signaling the ad selector with an indication that ad content should be provided for the ad break.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a multi-level digital program insertion arrangement. (ok, see new FIG. 1)

FIG. 2 is an action flow diagram of an embodiment of a multi-level digital program insertion.

FIG. 3 is a flow chart of an embodiment of a multi-level digital program insertion.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Overview

Ad splicers may be arranged in a tiered fashion so that one or more top tier ad splicers in the hierarchy serve a primary geographic region for the purpose of inserting ads that play in the entire large geographic region. Sub-regions of the large geographic region may be served by ad splicers of a second tier; sub regions of the sub-regions may be served by ad splicers of a third tier, and so on. The hierarchy of splicers may be arranged so that ads inserted in higher-level tiers flow through the lower-level tiers.

Multi-Level Digital Program Insertion Arrangement

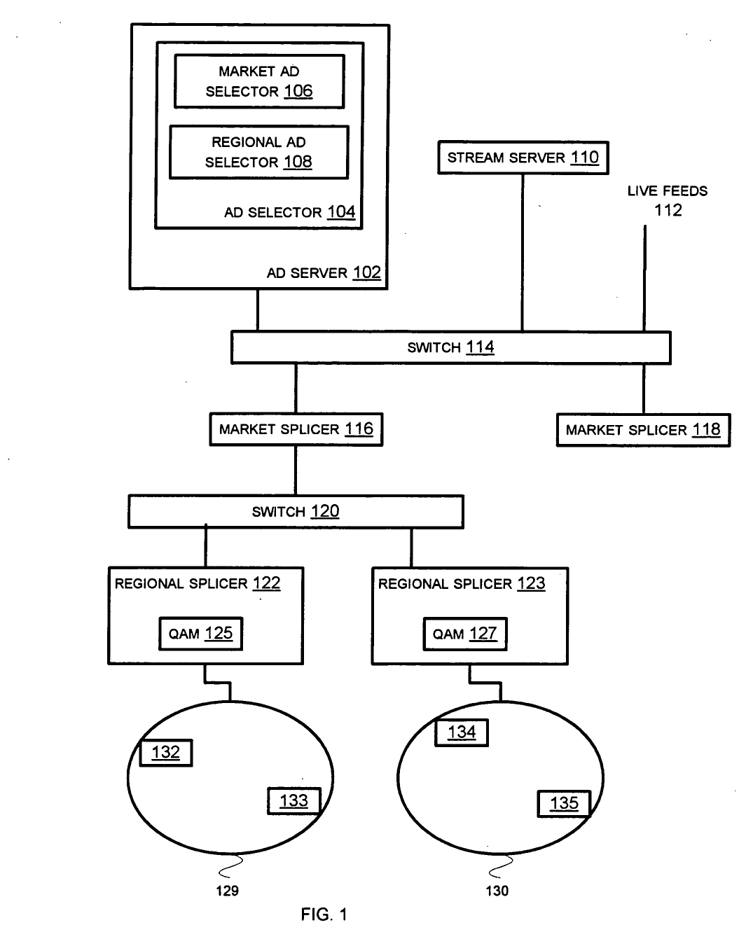

FIG. 1 is a block diagram of an embodiment of a multi-level digital program insertion arrangement. The arrangement comprises an ad server 102, a stream server 110, an encoder 112, a switch 114, market splicers 116 and 118, switches 114 and 120, regional splicers 122 123, and regional distribution networks 129 130.

One or more ad servers 102 provide streaming of ad content to other system components, such as splicers 116, 118, 122, and 123. Among other things, the splicers 116, 118, 122, and 123 insert ad content into program streams. A program stream is a data stream usually including video and audio content. The program stream may be sent by content providers to content distributors such as cable television systems, with the goal of making the program content available for viewing by subscribers.

One or more stream servers 110 may provide streaming of ad content. In some implementations, the ad servers 102 may perform ad content streaming. At least some of the splicers 116 118 122 123 may, in addition to stream splicing, perform multiplexing, digital to analog conversion, modulation, multiplexing, and various other functions.

The ad content to be streamed may take the form of digital files stored by one or multiple storage systems, such as a disk array or a memory cache. The ad server 102 may include or be a part of an ad management system that provides for the uploading, storage, selection, and retrieval of ad content. The ad server 102 may retain and access ad content and/or related information (e.g. metadata about the ad content).

The ad server 102 may in some implementations incorporate market-wide ad selector logic 106 and regional (e.g. a subset of a market) ad selector logic 108. The use of market ad selector logic 106 or regional ad selector 108 logic may depend, at least in part, on the intended scope of distribution of the ad content, e.g. region or market distribution. The ad selector 104 may receive an ad break indication for a program stream, such as an SCTE-30 message, and may apply one or more ad schedules, as well as other information, to determine one or more ads to select for insertion in the program. The ad selector 104 may identify one or more files comprising the ad content to insert.

The ad server 102, ad selector 104, and/or ad stream server 110 logic may be present in one system component or spread across several components, and the functions thereof may be centralized at one physical location or distributed over multiple locations.

The stream server 110 obtains selected ad content and streams this content for use by other system components, such as splicers 116, 118, 122, and 123, which insert the ad content into program streams. The ad server 102 may identify to the stream server 110 one or more files comprising the ad content to stream. The ad server 102 may also identify to the stream server 110 a time as which streaming of the ad content should occur in order to meet the conditions for timely splicing of the ad content into the program stream. The stream server 110 and/or the ad server 102 may communicate with one or more of the splicers 116 118 122 123 to indicate that the ad content should be spliced into the program stream.

A content distribution system, such as a cable television provider, may process several or many program streams using one or more encoders. The program streams may be received from satellite systems or by way of other distribution mechanisms. One or more encoders 112 receive one or more program streams, and/or a multiplex of program streams, and may perform such functions as decryption, compression, and/or analog to digital conversion. Encoding a content stream may include encoding differing parts of the content, such as the video and the audio, using different algorithms. The encoder 112 provides encoded program streams to one or more of the market splicers 116, 118 via the switch 114.

The switch 114 provides communication paths between the various system components, such as the ad server 102, the stream server 110, the encoder 112, and the market splicers 116, 118, enabling these components to communicate streams and control information. Some implementations may include multiple switches, a router or routers, hubs, direct connections, or other connectivity mechanisms. In some implementations, differing types of traffic may use different networking paths. For example, one switch may provide for exchange of control information, while another switch or other mechanism may be employed for streams.

The market splicers 116 118 detect ad break indications in program streams. Ad break indications may be identified in various ways, including by SCTE-35 cue packets (where the program streams have an MPEG format) and digitized DTMF tones. The market splicers 116 118 notify the ad server 102 and/or the stream server 110 of ad breaks. When the stream server 110 is notified, it may in turn notify the ad server 102. The ad server 102 may invoke market ad selection logic 106 to select ad content to insert at the break. If ad content having a market-wide scope is selected, the stream server 110 may be notified to stream a file or files comprising the market-wide ad content, and the market splicers 116 and/or 118 provided with information enabling splicing of the ad content into the program stream.

The market splicers 116 and/or 118 may insert the ad content at the ad insertion point into the program stream. The ad break indication may then be destroyed/replaced/invalidated. If no market ad is selected and inserted, the ad break indication may be retained in the program stream.

The switch 120 provides communication paths between the market splicers 116 118 and downstream components such as regional splicers 122 123. The programming streams provided by the market splicers 116 118 may be communicated using the switch 120. Some implementations may include multiple switches, one or more routers, hubs, direct connections, or other connectivity means. The networking capability provided may include communications capability (not shown in FIG. 1) with upstream system components.

The regional splicers 122 123 may receive programming stream(s) provided by the market splicers 116 118. The programming stream(s) from the market splicers 116 118 may include market scope ads and/or ad insertion points, depending on actions taken by the market splicers 116 118. When an ad break is retained in a program stream, the regional splicers 122 123 may recognize the ad break and request that an ad or ads be selected for insertion. The ad server 102 may invoke the regional ad selection 108 logic to identify region-wide ad or ads that may be inserted into the programming content at the ad break. The regional ad selection 108 logic may identify different ads to be inserted by each regional splicer 122 123, because they serve different distribution regions.

In addition to splicing in ad content destined for use within one or several regions of the distribution region they serve, the regional splicers 122 123 may multiplex multiple programs into one multi-program transport stream (MPTS) and modulate the MPTS. In some implementations, only those programs actually being tuned by set top boxes 132-135 in the region served are multiplexed into the MPTS; other programs are left out. This selective mixing and modulating results in a modulated content stream that includes only those programs to which user equipment is tuned within the region, thus utilizing bandwidth in a judicious fashion. Quadrature amplitude modulators (QAMs 125 and 127) may perform the modulation for compatibility with digital user equipment. In some implementations, the QAM logic 125 127 may be comprised by the regional splicing components 122 123.

The regional distribution networks 129 130 comprise various equipment that delivers the modulated MPTS, which may be analog or digital in format, and delivers it to end-user equipment, such as the set-top boxes 132-135 and/or televisions. The set-top boxes 132-135 may incorporate digital and/or analog receivers.

In some embodiments, information in a program stream may indicate that an ad break indication is to be associated with a particular splicer(s), region(s), or tier(s) of the ad insertion hierarchy. For example, an extension to an SCTE-35 ad break indication may indicate that the ad break is to be filled at the second tier of an ad insertion hierarchy. Splicers in tiers other than the second tier may ignore the ad break indication, while second-tier splicers that detected the ad break indication may signal the ad selector/server for ad content.

In some embodiments, the ad insertion system may associate ad breaks with particular tiers of the ad insertion hierarchy, and may signal splicers in the hierarchy to cause them to respond to or ignore the ad breaks. For example, an ad splicer at the top tier of the hierarchy may detect an ad break, and if the ad break is for a tier lower in the hierarchy, the ad splicer may signal downstream splicers that are not in the proper tier to ignore the ad break before it reaches them, or may insert information in the program stream to associate the ad break with a particular splicer(s), region(s), or tier(s).

Ad Selection

Ad selection may include and/or involve identifying an ad splicerad splicer that provides an indication of an ad break in a program stream. The ad splicer providing the ad break indication is typically a stream splicer, but may also include and/or involve one or more of stream multiplexing/demultiplexing, coding, encrypting/decrypting, compression/decompression, and/or modulation. Identifying one or more correct ad splicers may involve consulting one or more ad schedules from one or more systems such as traffic and/or billing systems. Different tiers may have different associated as schedules.

The ad server 102 may attempt to select one or more ads particular to a market(s) or region(s) served by the ad splicer. Selected ads may be streamed to the ad splicer for insertion in the program stream. When no ad is selected, an indication may be provided to the ad splicer to cause the ad break to be retained in the program stream for possible detection by one or more ad splicers downstream in a lower tier One manner of implementing ad selection may include and/or involve attempting to select one or more ads tailored to a multi-regional market served by the ad splicer 116 or 118, e.g. market ad selection. In some implementations localized ad selection may also or alternatively include and/or involve applying ad schedules for a multi-region market.

In some instances, ad selection may include and/or involve applying ad schedules pertaining to one or more specific regions of the multi-region market which are served by the ad splicer 122 or 123, e.g. regional ad selection. In some situations, regional ad selection may include and/or involve applying ad schedules pertaining to both the entire multi-region market of which a region or regions are a part, and/or applying ad schedules pertaining to the particular region or regions served by the ad splicer. In this manner it may be possible to ascertain, at least in part, whether a market-wide ad should take precedence over a regional ad.

The market wide and/or regional ad selection may also or alternatively include and/or involve applying metadata for the program stream to at least in part affect a selection of the one or more ads. Market wide and/or regional ad selection may include and/or involve applying demographic information for a multi-region market or for a particular region or regions within that market to at least in part affect a selection of the one or more ads. Market wide or regional ad selection may include and/or involve applying ad content metadata to at least in part affect a selection of one or more ads, and/or applying channel metadata for a channel including the program stream to at least in part affect a selection of the ad or ads.

When no ad is selected, an indication may be provided to the ad splicer to cause the ad splicer to retain the ad break indication in the program stream. There may be various manners of providing an indication to a ad splicer that the ad break should be retained in the program stream (henceforth, ‘ad break retention’), including but not limited to failing to provide an indication to a ad splicer within a required response time interval that an ad or ads was selected.

Ad Insertion

The ad splicer that identifies an ad break indication in a program stream may signal the ad server 102 with an indication that ad content should be provided for the ad break, and may also provide the ad server 102 with ad splicer identification information, e.g. a splicer id value, network address, and so on. When ad content is provided by the ad server 102 in response, the ad splicer may insert the ad content into the program stream at an ad break location, and remove the ad break indication from the program stream. When no ad is identified for insertion by the ad server 102, the ad break indication may be retained in the program stream, thus possibly causing downstream splicers (or other ad splicers) to detect the ad break and generate a request for ad content.

Ad break retention may include and/or involve streaming the program stream including the ad break indication to a downstream device, such as regional splicers 122 123. The downstream splicers 122 123 may detect the ad break indication and signal the ad selector 104 with a device identifier and indication that ad content should be provided to the identified device for the ad break. In some situations the ad content selected and provided for insertion by an upstream device may be less than enough to fill an ad break. Some implementations could include and/or involve procedures to adjust information of the ad break indication retained in the program stream to account for the extent of the inserted ad content, thus leaving open the possibility that a downstream device could splice in regional ad content in the ad break area that was not filled by the upstream device.

In some situations, ad break retention could include and/or involve retaining or removing the ad break indication according to one or more system configuration settings. For example, a market splicer 116 118 may remove the ad break indication from the program stream when the ad server 102 and/or stream server 110 provides an indication that no ad insertion will be done by downstream devices.

Signal Exchange in One Implementation of Multi-Level Digital Program Insertion

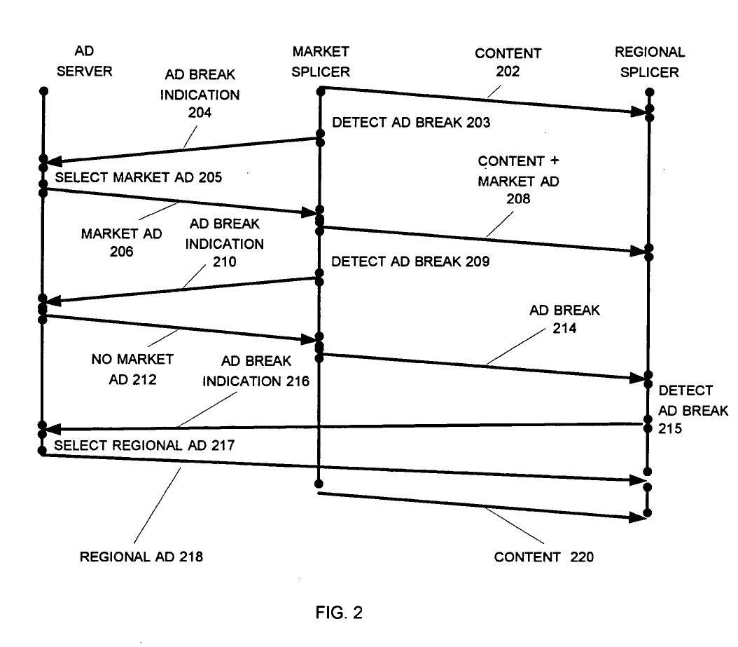

FIG. 2 is an action flow diagram of an embodiment of multi-level digital program insertion. At 202, a market splicer receives a content stream from a content source, such as an encoder (not shown) and streams that content stream to a region splicer. At 203, the market splicer detects an ad break indicator. At 204, the market splicer sends an ad break indication, including information that identifies itself, to an ad server/selector. At 205, the ad server/selector selects an ad having market-wide scope. At 206, the market ad content is streamed to the market splicer. At 208, the content stream continues to stream from the market splicer with the market ad content included.

At 209, the market splicer detects another ad break indicator. At 210, the market splicer informs the ad server/selector of the ad break indication, including information identifying itself. At 212, the ad server/selector informs the market splicer that no ad was selected for this ad break indicator. At 214, the market splicer continues to send the content stream to the regional splicer, with the ad break indicator retained therein.

At 215, the regional splicer detects the ad break indicator in the content stream from the market splicer. At 216, the regional splicer sends an ad break indication to the ad server/selector, including information identifying itself. At 217, the ad server/selector identifies a regional ad to be inserted in the programming content stream by the regional splicer. At 218, the regional ad is streamed to the regional splicer. The content stream continues to stream (220) to the regional splicer, which inserts the regional ad into the content stream at the ad break location.

Process Flow in One Implementation of Multi-Level Digital Program Insertion

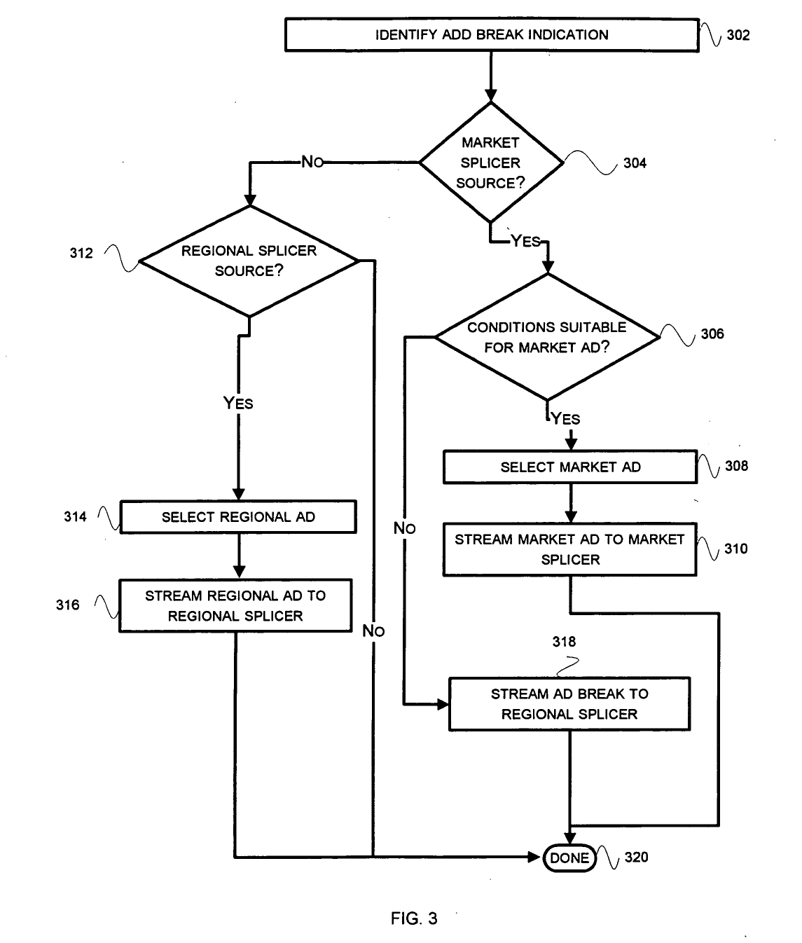

FIG. 3 is a flow chart of an embodiment of multi-level digital program insertion. At 302, an ad break indication is detected. At 304, it is determined whether a market splicer generated the ad break indication. If yes, at 306, a determination is made as to whether conditions are suitable for a market wide scope ad. If yes, at 308 a market-wide ad is selected. At 310, the market ad is streamed to the market splicer which generated the ad break indication. At 320, the process concludes.

At 306 it may be determined that conditions are not suitable to selection of a market-wide ad. If this is the case, at 318 the stream break indicator is retained in the content stream that is provided to the regional splicer.

At 304 it may be determined that a market splicer did not generate the ad break indication. If this is the case, at 312 it is determined if a regional splicer generated the ad break indication. If a regional splicer generated the ad break indication, at 314 a regional ad is selected. At 316, the regional ad is streamed to the regional splicer for insertion into the program stream.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will require optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A method comprising:
identifying a device that provided an indication of an ad break in a program stream;
attempting to select one or more ads particular to a region or regions served by the device;
if an ad or ads particular to a region or regions served by the device is selected, causing the ad or ads to stream to the device; and
otherwise, providing an indication to the device that the ad break should be retained in the program stream.

2. The method of claim 1, wherein the a device that provided an indication of an ad break in a program stream further comprises:
a device functioning as at least one of a stream splicer, stream multiplexer, or stream modulator.

3. The method of claim 1, wherein attempting to select one or more ads particular to a region or regions served by the device further comprises:
attempting to select one or more ads tailored to a multi-regional market served by the device.

4. The method of claim 1, wherein attempting to select one or more ads particular to a region or regions served by the device further comprises:
applying ad schedules for a multi-region market served by the device.

5. The method of claim 1, wherein attempting to select one or more ads particular to a region or regions served by the device further comprises:
applying ad schedules for one or more regions of a multi-region market served by the device.

6. The method of claim 1, wherein attempting to select one or more ads particular to a region or regions served by the device further comprises:
applying one or more ad schedules for a multi-region market served by the device, and ad schedules for one or more regions of the market, to ascertain, at least in part, whether a market-wide ad should take precedence over a regional ad.

7. The method of claim 1, wherein attempting to select one or more ads particular to a region or regions served by the device further comprises:
applying metadata for the program stream to at least in part affect a selection of the one or more ads.

8. The method of claim 1, wherein attempting to select one or more ads particular to a region or regions served by the device further comprises:
applying demographic information for a multi-region market served by the device to at least in part affect a selection of the one or more ads.

9. The method of claim 1, wherein providing an indication to the device that the ad break should be retained in the program stream further comprises:
failing to provide an indication to the device within a required response time interval that an ad or ads was selected.

10. The method of claim 1, wherein causing the ad or ads to stream to the device further comprises:
signaling a stream server with one or more indications of the ad or ads to stream.

11. The method of claim 1, wherein attempting to select one or more ads particular to a region or regions served by the device further comprises:
applying ad content metadata to at least in part affect a selection of the one or more ads.

12. The method of claim 1, wherein attempting to select one or more ads particular to a region or regions served by the device further comprises:
applying channel metadata for a channel comprising the program stream to at least in part affect a selection of the ad or ads.

13. A method comprising:
identifying an ad break indication in a program stream;
signaling an ad selector with an indication that ad content should be provided for the ad break, and with device identification information;
when ad content is provided in response, inserting the ad content into the program stream at an ad break location, and removing the ad break indication from the program stream; and
otherwise, retaining the ad break indication in the program stream.

14. The method of claim 13, wherein retaining the ad break indication in the program stream further comprises:
streaming the program stream including the ad break indication to a downstream device, the downstream device detecting the ad break indication and signaling the ad selector with an indication that ad content should be provided for the ad break, and with identification information for the downstream device.

15. The method of claim 13, wherein retaining the ad break indication in the program stream further comprises:
when the ad content inserted into the program stream at the ad break is less than enough to fill the ad break, adjusting information of the ad break indication retained in the program stream to account for the inserted ad content.

16. A method comprising:
identifying an ad break indication in a program stream;
signaling an ad selector with an indication that ad content should be provided for the ad break, and with device identification information;
when ad content is provided in response, inserting the ad content into the program stream at an ad break location, and removing the ad break indication from the program stream; and
when ad content is provided in response, inserting the ad content into the program stream at an ad break location, and retaining the ad break indication in the program stream.

17. The method of claim 16, wherein retaining the ad break indication in the program stream further comprises:
streaming the program stream including the ad break indication to a downstream device, the downstream device detecting the ad break indication and signaling the ad selector with an indication that ad content should be provided for the ad break, and with identification information for the downstream device.

18. The method of claim 16, wherein retaining the ad break indication in the program stream further comprises:
when the ad content inserted into the program stream at the ad break is less than enough to fill the ad break, adjusting information of the ad break indication retained in the program stream to account for the inserted ad content.

19. A method comprising:
identifying an ad break indication in a program stream; signaling an ad selector with an indication that ad content should be provided for the ad break, and with device identification information;
when ad content is provided in response, inserting the ad content into the program stream at an ad break location, and removing the ad break indication from the program stream; and
removing the ad break indication from the program stream when no ad insertion will be done by downstream devices, and retaining the ad break indication in the program stream otherwise.

20. The method of claim 19, wherein retaining the ad break indication in the program stream further comprises:
streaming the program stream including the ad break indication to a downstream device, the downstream device detecting the ad break indication and signaling the ad selector with an indication that ad content should be provided for the ad break, and with identification information for the downstream device.

21. The method of claim 19, wherein retaining the ad break indication in the program stream further comprises:
when the ad content inserted into the program stream at the ad break is less than enough to fill the ad break, adjusting information of the ad break indication retained in the program stream to account for the inserted ad content.

22. The method of claim 19, wherein removing the ad break indication from the program stream when no ad insertion will be done by downstream devices, and retaining the ad break indication in the program stream otherwise further comprises:
retaining or removing the ad break indication according to one or more configuration settings.

23. The method of claim 19, wherein removing the ad break indication from the program stream when no ad insertion will be done by downstream devices, and retaining the ad break indication in the program stream otherwise further comprises:
removing the ad break indication from the program stream when the ad selector and-or a stream server provides an indication that no ad insertion will be done by downstream devices.
